(19) United States
(12) Patent Application Publication
(10) Pub. No.: US 2016/0042095 A1
(43) Pub. Date: Feb. 11, 2016

(54) METHOD AND COMPUTER SYSTEM FOR PARTITIONING A 3D PRINTABLE MODEL

(71) Applicants: XYZPRINTING, INC., New Taipei City (TW); KINPO ELECTRONICS, INC., New Taipei City (TW); CAL-COMP ELECTRONICS & COMMUNICATIONS COMPANY LIMITED, New Taipei City (TW)

(72) Inventors: Ching-Yuan Chou, New Taipei City (TW); Wen-Ten Lin, New Taipei City (TW)

(21) Appl. No.: 14/708,600

(22) Filed: May 11, 2015

(30) Foreign Application Priority Data
Aug. 8, 2014 (TW) 103127311

(51) Int. Cl. G06F 17/50

(52) U.S. Cl. CPC G06F 17/50

(57) ABSTRACT

A method for partitioning a 3D printable model includes the steps of: establishing a standard build volume along three axes; accessing the 3D printable model and accessing a partitioning parameter upon determining that dimensions of the 3D printable model exceed the standard build volume; partitioning the 3D printable model into a plurality of 3D model segments based on the partitioning parameter; determining whether dimensions of each of the 3D model segments are greater than a threshold volume; adjusting the partitioning parameter when a result of the determination is negative; and forming engaging structures on cutting planes of adjacent two of the 3D model segments when the result of the determination is affirmative.

### CROSS-REFERENCE TO RELATED APPLICATION

This application claims priority of Taiwanese Patent Application No. 103127311, filed on Aug. 8, 2014, the entire disclosure of which is incorporated herein by reference.

### BACKGROUND OF THE INVENTION

1. Field of the Invention

The invention relates to processing of virtual objects, more particularly to a method and a computer system partitioning a three-dimensional (3D) printable model.

2. Description of the Related Art

Regarding the conventional three-dimensional (3D) printing technology, when dimensions of a 3D printable model exceed a build volume of a 3D printer, users are usually required to partition the 3D printable model into several model segments on their own, and assemble physical 3D objects printed by the 3D printer from the model segments. However, for users who are not provided with the knowledge to partition or edit the 3D printable model using 3D modeling software, a more convenient and applicable way is desired to overcome the issue of excessively large dimensions of a 3D printable model.

### SUMMARY OF THE INVENTION

Therefore, an object of the present invention is to provide a method and a computer system for partitioning a three-dimensional (3D) printable model in an automated manner.

According to a first aspect of the present invention, the method is to be implemented using a computer system, and comprises the steps of:
(A) establishing, using the computer system, a standard build volume along three axes;
(B) accessing, using the computer system, the 3D printable model, and accessing a preset partitioning parameter upon determining that dimensions of the 3D printable model thus accessed exceed the standard build volume;
(C) partitioning, by the computer system, the 3D printable model into a plurality of 3D model segments, which have dimensions smaller than the standard build volume, based on the partitioning parameter;
(D) determining, by the computer system, whether dimensions of each of the 3D model segments are greater than a threshold volume;
(E) when a result of the determination made in step (D) is negative, adjusting, using the computer system, the partitioning parameter, and performing steps (C) and (D);
(F) when the result of the determination made in step (D) is affirmative, modifying, using the computer system, any adjacent two of the 3D model segments by forming corresponding engaging structures respectively on corresponding cutting planes of said adjacent two of the 3D model segments.

According to second aspect of the present invention, the computer system comprises a build volume creation module, a size determination module, and a model partitioning module. The build volume creation module is for establishing a standard build volume along three axes. The size determination module accesses the 3D printable model, and determines whether dimensions of the 3D printable model exceed the standard build volume. The model partitioning module partitions the 3D printable model into a plurality of 3D model segments, which have dimensions smaller than the standard build volume, based on a preset partitioning parameter when the size determination module determines that the dimensions of the 3D printable model exceed the standard build volume. The model partitioning module adjusts the partitioning parameter upon determining that dimensions of at least one of the 3D model segments are not greater than a threshold volume. The model partitioning module re-partitions the 3D printable model in no a plurality of 3D model segments, which have dimensions smaller than the standard build volume, based on the partitioning parameter thus adjusted. The model partitioning module modifies any adjacent two of the 3D model segments by forming corresponding engaging structures respectively on corresponding cutting planes of the adjacent two of the 3D model segments.

According to a third aspect of the present invention, the method for partitioning a 3D printable model is to be implemented using a computer system, and includes the steps of:
establishing, using the computer system, a standard build volume along three axes;
accessing, using the computer system, the 3D printable model;
calculating, by the computer system, a partitioning parameter based on dimensions of the 3D printable model and the standard build volume upon determining that dimensions of the 3D printable model thus accessed exceed the standard build volume;
partitioning, by the computer system, the 3D printable model into a plurality of 3D model segments, which have dimensions smaller than the standard build volume, based on the partitioning parameter thus calculated; and
modifying, using the computer system, any adjacent two of the 3D model segments by forming corresponding engaging structures respectively on corresponding cutting planes of said adjacent two of the 3D model segments.

### BRIEF DESCRIPTION OF THE DRAWINGS

Other features and advantages of the present invention will become apparent in the following detailed description of the embodiments with reference to the accompanying drawings, of which:

FIG. 1 is a flow chart of a first embodiment of a method for partitioning a 3D printable model according to the present invention;

FIG. 2 is a block diagram of an embodiment of a computer system for implementing the method according to the present invention;

FIG. 3 is a schematic diagram illustrating a 3D printable model to be partitioned and a standard build volume established in the first embodiment of the present invention;

FIG. 4 is a schematic diagram illustrating the 3D printable model to be partitioned and a standard partition volume set in the first embodiment of the present invention;

FIG. 5 is a schematic diagram illustrating a plurality of 3D model segments into which the 3D printable model is partitioned according to the standard partition volume of FIG. 4;

FIG. 6 is a schematic diagram illustrating a plurality of 3D model segments into which the 3D printable model is partitioned according to an adjusted standard partition volume;

FIG. 7 is a schematic diagram illustrating a plurality of 3D model segments into which the 3D printable model is partitioned according to two different adjusted standard partition volumes;

FIG. 8 is a schematic diagram illustrating that cutting planes of adjacent two of the 3D model segments are formed with corresponding engaging structures, respectively;

FIG. 9 is a schematic diagram illustrating that corresponding indication patterns are labeled on the cutting planes of adjacent two of the 3D model segments;

FIG. 10 is a schematic diagram illustrating that when a cutting plane of one of the 3D model segments has two separate parts, each of the separate parts is formed with an engaging structure engage correspondingly an adjacent one of the 3D model segments;

FIGS. 11 and 12 illustrate flow charts of a second embodiment of the method for partitioning a 3D printable model according to the present invention; and

FIGS. 13 to 15 illustrate an example of a 3D printable model being partitioned into 3D model segments according to the second embodiment.

### DETAILED DESCRIPTION OF THE EMBODIMENTS

Before the present invention is described in greater detail with reference to the accompanying embodiments, it should be noted herein that like elements are denoted by the same reference numerals throughout the disclosure.

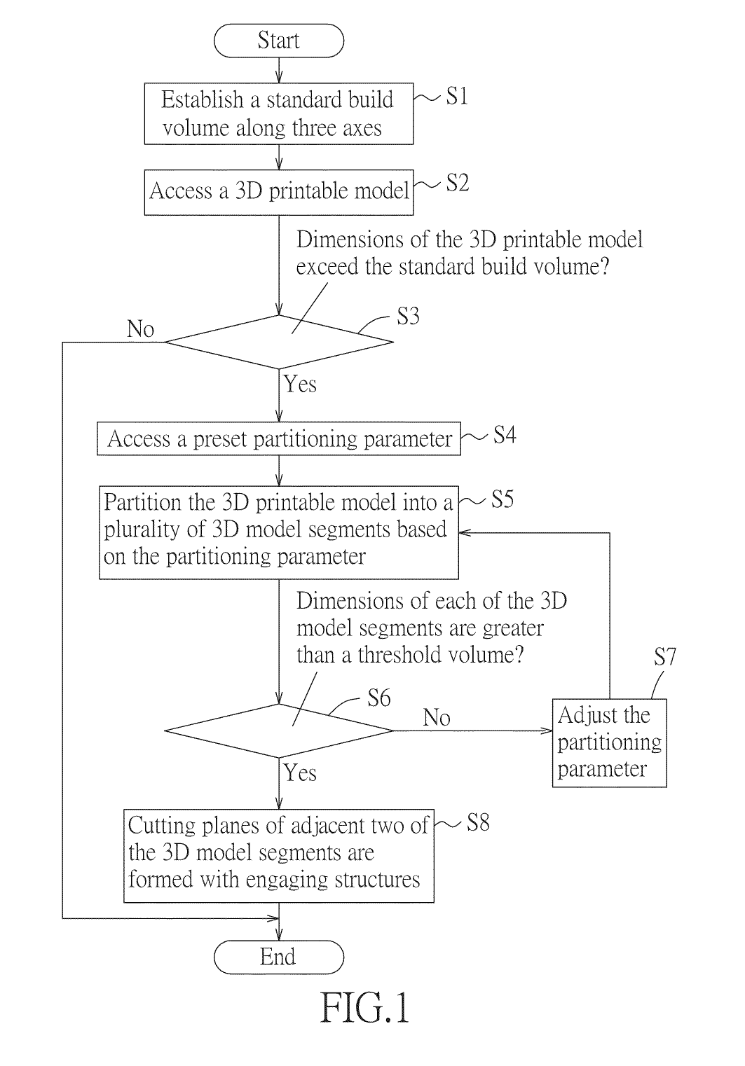

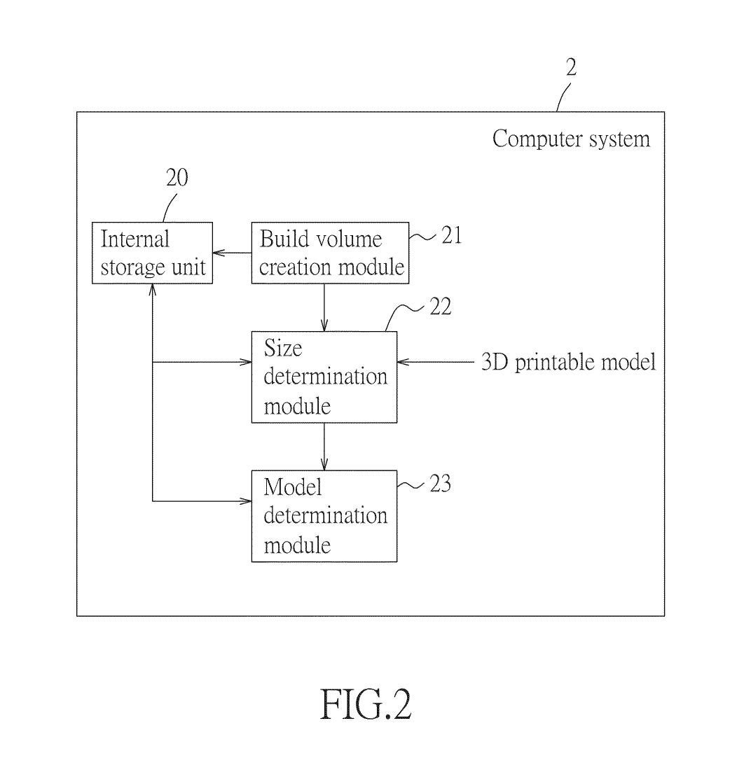

Referring to FIG. 1 and FIG. 2, a first embodiment of a method for partitioning a three-dimensional (3D) printable model according to the present invention is illustrated. The method is to be implemented using a computer system 2. The computer system 2 is configured to access a 3D printable model from an internal storage unit 20, or an external storage device (not shown). For implementing the method of the present invention, an embodiment of the computer system 2 includes a build volume creation module 21, a size determination module 22, and a model partitioning module 23. These modules 21 to 23 may be preloaded onto the computer system 2, and may be software programs or firmware programs which are to be executed by a central processing unit or an image processor of the computer system 2. The computer system 2 is usually used in combination with or integrated with a 3D printer (not shown), so as to feed a 3D printable model file to the 3D printer.

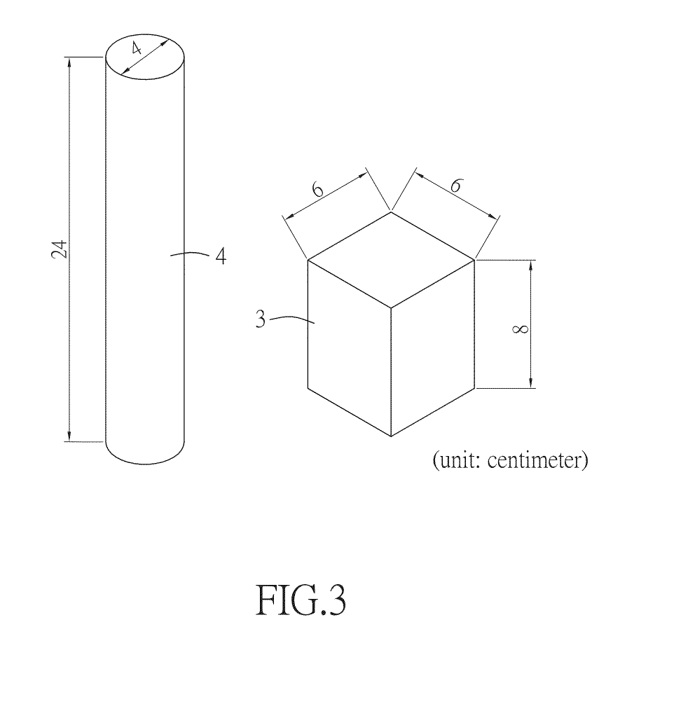

In order to ensure that dimensions of the 3D printable model do not exceed a build volume of the 3D printer, in step S1 of FIG. 1, the build volume creation module 21 of the computer 2 is configured to establish a standard build volume 3 along three axes (e.g., X, Y and Z axes) based on a stock build volume of the 3D printer. Referring to FIG. 3, the standard build volume 3 is exemplified by a cube with a length of 6 centimeters, a width of 6 centimeters and a height of 8 centimeters. The standard build volume 3 thus established is subsequently stored in the storage unit 20.

In step S32 of FIG. 1, the size determination module 22 of the computer system 2 is configured to access a to-be-printed 3D printable model 4, which is exemplified by a cylinder having a diameter of 4 centimeters and a height of 24 centimeters as best shown in FIG. 3. The size determination module 22 further accesses the standard build volume 3 stored in the storage unit 20.

In step S3 of FIG. 1, the size determination module 22 is configured to compare the 3D printable model 4 with the standard build volume 2, so as to determine whether the dimensions of the 3D printable model 4 exceed the build volume of the 3D printer. Referring to FIG. 3, the size determination module 22 determines that a projected area (i.e., a base area) of the 3D printable model 4 onto a surface defined by the length and the width of the standard build volume 3 does not exceed an area formed by the length and the width of the standard build volume 3. However, the height of the 3D printable model 4 is determined as exceeding the height of the standard build volume 3. Therefore, the size determination module 22 determines that the 3D printable model 4 is required to be partitioned into a plurality of 3D model segments that have dimensions not exceeding the standard build volume 3.

In step S4 of FIG. 1, the model partitioning module 23 of the computer system 2 is configured to access a preset partitioning parameter.

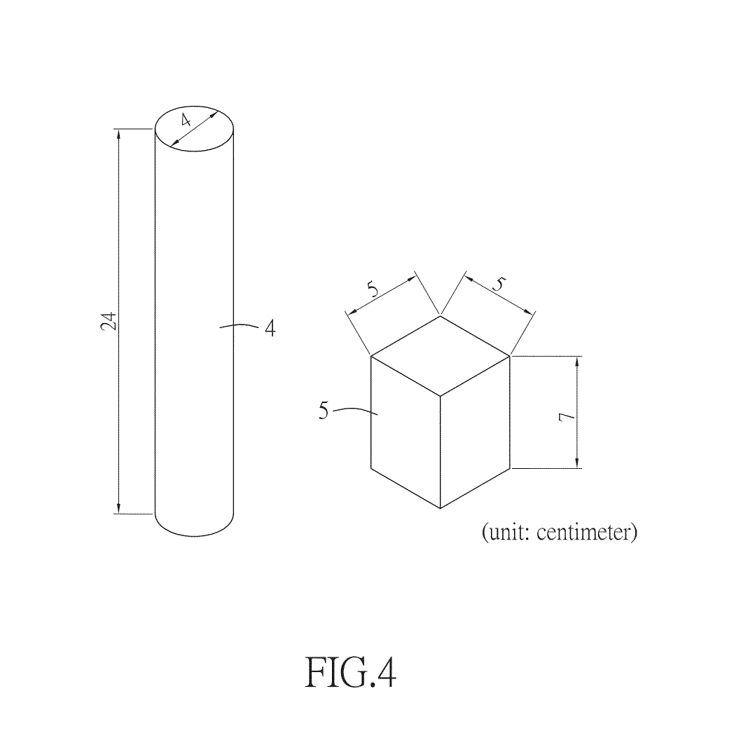

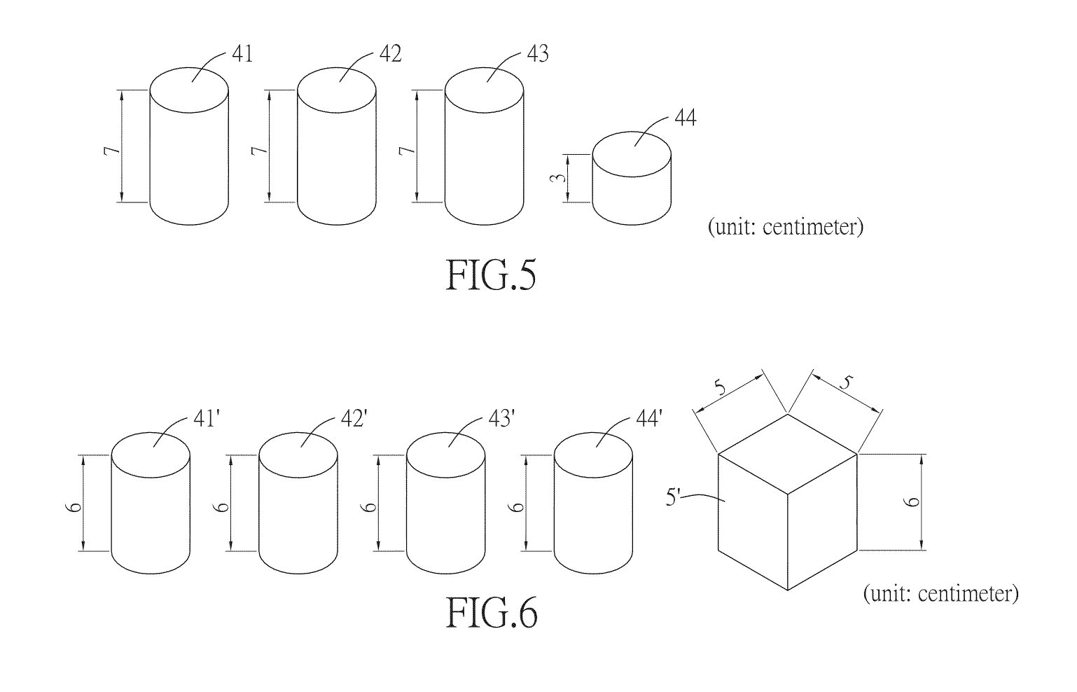

In step S5 of FIG. 1, referring to FIG. 4 and FIG. 5, the model partitioning module is configured to partition the 3D printable model 4 into a plurality of 3D model segments 41 to 44 based on the partitioning parameter. The partitioning parameter is set according to a predefined standard partitioning volume 5 as best shown in FIG. 4, Moreover, the standard partitioning volume 5 is usually defined as a maximum build volume smaller than the standard build volume 3 established in step S1, such as a cube with a length of 5 centimeters, a width of 5 centimeters and a height of 7 centimeters. Therefore, the 3D printable model 4 is partitioned into three 3D model segments 41 to 43 with a height of 7 centimeters and one 3D model segment 44 with a height of 3 centimeters.

In step S6, the model partitioning module 23 is configured to determine whether dimensions of each of the 3D model segments 41 to 44 are greater than a threshold volume. In this embodiment, the threshold volume is provided for alleviating an issue that dimensions of some of the 3D model segments into which the 3D printable model 4 is partitioned are too small for subsequent assembly processing. Hence, the threshold volume may serve as minimum dimensions of the 3D model segments suitable for the subsequent assembly processing, and may be adjusted to meet different requirements for practical assembly of physical 3D objects printed from the 3D model segments. In this embodiment, the threshold volume is exemplified by one half of the predefined standard partitioning volume 5, i.e., a height of the threshold volume is one half of that of the predefined standard partitioning volume 5. In this way, when the model partitioning module 23 determines that the dimensions (height) of the 3D model segments 44 are not greater than the threshold volume (such as height), the flow proceeds to step S7.

In step S7, the model partitioning module 23 is configured to adjust the partitioning parameter, and the flow goes back to step S5, in which the model partitioning module 23 is configured to re-partition the 3D printable model 4 into a plurality of 3D model segments 41′ to 44′ as best shown in FIG. 6 based on the partitioning parameter thus adjusted.

Specifically, in step S7, the model partitioning module 23 adjusts the partitioning parameter by adjusting dimensions of the standard partitioning volume 5, for example, the standard partitioning volume 5′, thus adjusted has a height reduced from 7 to 6 centimeters, and the flow then goes back to step S5, in which the 3D printable model 4 is partitioned once again into a plurality of 3D model segments 41′ to 44′ each of which has a height of 6 centimeters as best shown in FIG. 6 based on the standard partitioning volume 5′ thus adjusted. Subsequently, in step S6, the model partitioning module 23 determines that the dimensions (such as height) of each of the 3D model segments 41′ to 44′ are greater than (the height of) the threshold volume, i.e., 3.5 centimeters.

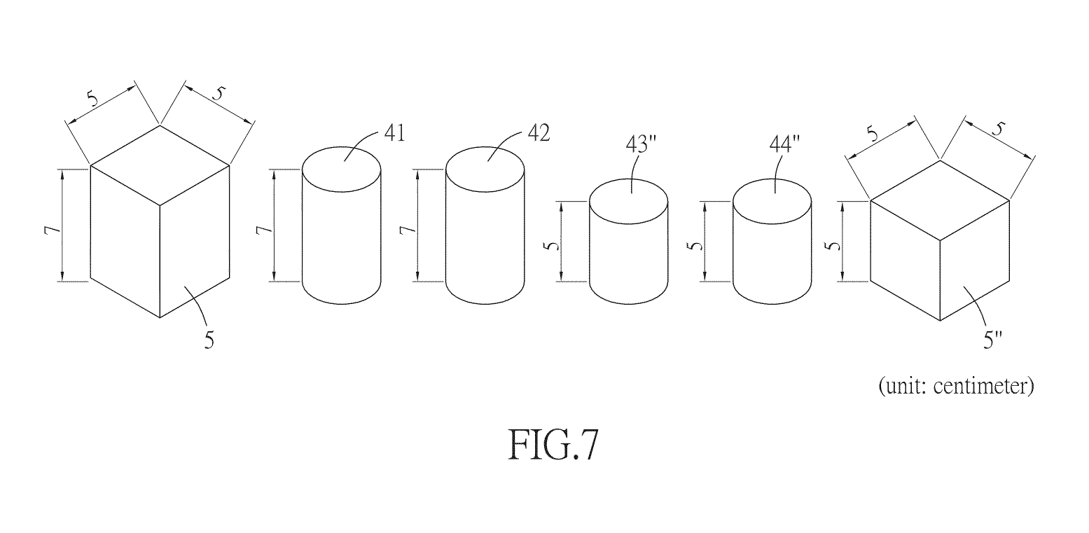

Alternatively, in step S7, the model partitioning module 23 may merely adjust a partitioning volume particularly for the 3D model segment 44 whose dimensions are not greater than the threshold volume, and particularly for the 3D model segment 43 which is adjacent to the 3D model segment 44. For example, the standard partitioning volume 5″ thus adjusted particularly for the 3D model segments 43 and 44 has a height reduced from 7 to 5 centimeters, and the standard partitioning volume 5 particularly for the 3D model segments 41 and 42 is maintained. Subsequently, the flow goes back to step S5, in which the 3D printable model 4 may be re-partitioned into a plurality of 3D model segments 41, 42, 43″ and 44″ as best shown in FIG. 7. Each of the 3D model segments 41 and 42 has the height of 7 centimeters, and each of the 3D model segments 43″ and 44″ has a height of 5 centimeters. In this way, in step S6, the model partitioning module 23 may determine that dimensions of each of the 3D model segments 41, 42, 43″ and 44″ are greater than the threshold volume.

It is noted that, in FIG. 7, the standard partitioning volume of this embodiment may have more than two sizes, that is to say, in step S5, the model partitioning module 23 may partition the 3D printable model 4 based on distinct standard partitioning volumes. Moreover, in step S6, when one or some of the 3D model segments into which the 3D printable model 4 is partitioned is determined to have dimensions not greater than the threshold volume, the model partitioning module 23 in step S7 may adjust dimensions of the standard partitioning volume for all of the 3D model segments, or may only adjust dimensions of the standard partitioning volume for parts of the 3D model segments. When the flow goes hack to step S5, the 3D printable model 4 is partitioned once again based on the standard partitioning volume thus adjusted, and then the determination of step S6 is performed. Steps S5 to S7 are repeated until the dimensions of each of the 3D model segments into which the 3D printable model 4 is partitioned are greater than the threshold volume.

In this way, by means of the model partitioning module 23 which determines whether the dimensions of each of the 3D model segments are greater than the threshold volume, and which correspondingly adjusts the partitioning parameter such that dimensions of each of the 3D model segments are greater than the threshold volume, the issue that the dimensions of some of the 3D model segments are too small for the subsequent assembly processing may be alleviated.

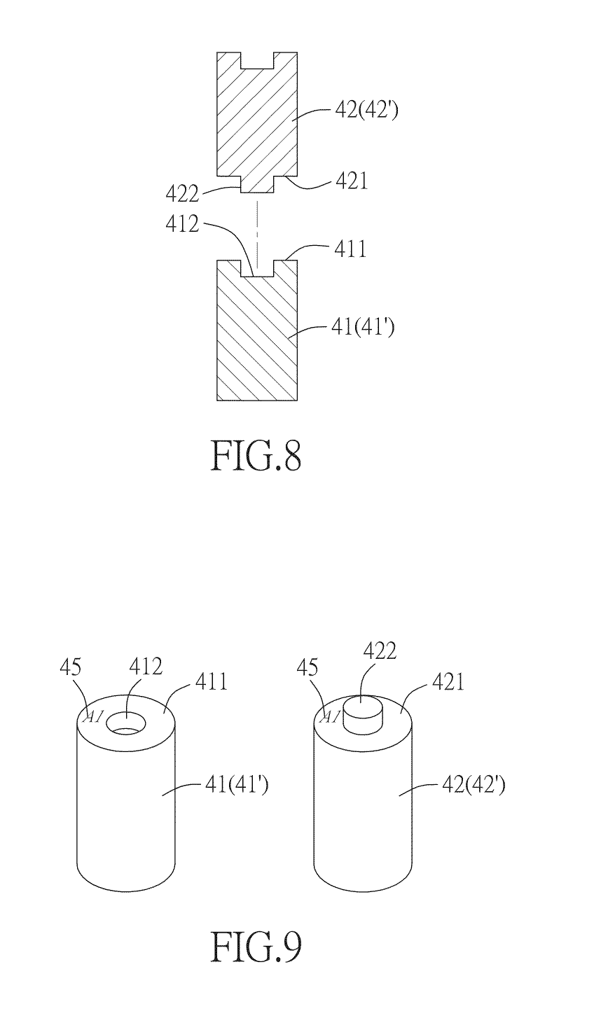

Finally, in step S8 of FIG. 1 and referring to FIG. 8, the model partitioning module 23 is configured to modify any adjacent two of the 3D model segments such that corresponding cutting planes of said adjacent two of the 3D model segments, such as a first cutting plane 411 of the 3D model segment 41 (41′) and a second cutting plane 421 of the 3D model segment 42 (42′) corresponding to the first cutting plane 411, resulting from the aforementioned partitioning process are formed with corresponding engaging structures 412 and 422, respectively. One of the engaging structures 412 may be a mortise, and the other one of the engaging structures 422 may be a tenon which is insertable into and tightly engages the mortise. However, the practical implementation of the engaging structures of this embodiment is not, limited to the disclosure herein, and may be any engaging mechanism which enables tight connection between the first cutting plane 411 and the second cutting plane 421.

Moreover, the aforementioned standard partitioning volumes 5, 5′ and 5″ of the partitioning parameter are set to ensure that dimensions of each of the 3D model segments, which are formed with a respective one of the engaging structures 412 and 422, are not greater (i.e., smaller) than the standard build volume 3. The aforementioned threshold volume may also be set according to dimensions of the engaging structures 412 and 422. That is to say, the threshold volume relates to the dimensions of the engaging structures 412 and 422. For example, in a scenario where a depth of the engaging structure 412 (i.e., mortise) is 0.2 centimeter and a length of the engaging structure 422 (i.e., tenon) is 0.2 centimeter, the height (or thickness) of the threshold volume should be set as 1.5 or 2 centimeters, considering volumes and strength of the physical 3D objects printed from the 3D model segments being required to satisfy an assembly standard.

In this way, when a file of the 3D model segments 41′ to 44′ (or 41, 42, 43″ and 44″) is outputted by the computer system 2 to the 3D printer, the corresponding physical 3D objects may be printed. By virtue of the engaging structures 412 and 422, the physical 3D objects may be aligned and combined effectively during assembly of the physical 3D objects.

In addition, when the number of the 3D model segments into which the 3D printable model is partitioned is relatively large, in order to facilitate finding of corresponding connecting surfaces of the physical 3D objects to be combined during the assembly process, the model partitioning module 23 is further configured to label the corresponding cutting planes of any adjacent two of the 3D model segments, such as the first cutting plane 411 of the 3D model segment 41 (41′) and the second cutting plane 421 of the 3D model segment 42 (42′) corresponding to the first cutting plane 411 as best shown in FIG. 9, with corresponding indication patterns 45, respectively. The indication patterns 45 may be, for example, at least one alphanumeric character.

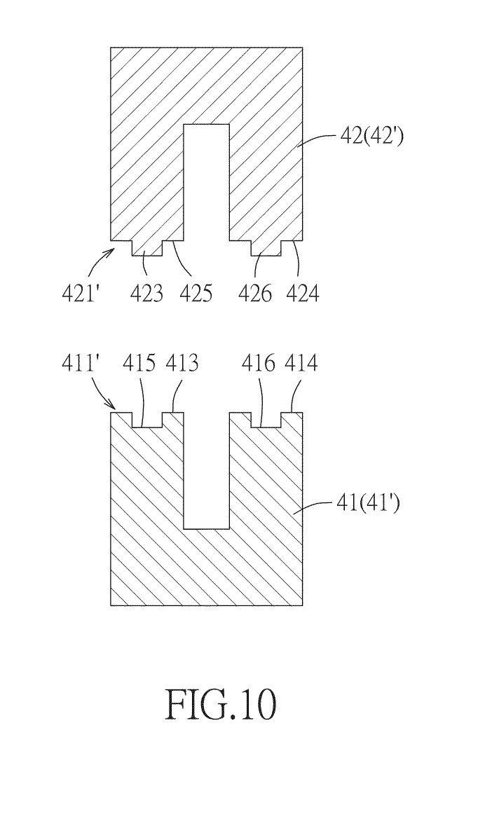

Furthermore, referring to FIG. 10, if the 3D printable model 4 is hollow, a cutting surface of each of the 3D model segments into which the 3D printable model 4 is partitioned, such as the first cutting plane 411′ of the 3D model segment 41 (41′) and the second cutting plane 421′ of the 3D model segment 42 (42′) corresponding to the first cutting plane 411′, has two separate parts 413 and 414 or 423 and 424. For the purpose of alignment and joining of the physical 3D objects printed from the 3D model segments 41 (41′) and 42 (42′), the model partitioning module 23 is configured to modify any adjacent two of the 3D model segments such that the two separate parts 413 and 414 of the first cutting plane 411′ are respectively formed with engaging structures 415 and 416, and such that the two separate parts 423 and 424 of the second cutting plane 421′ are respectively formed with engaging structures 425 and 426 corresponding to the respective engaging structures 415 and 416.

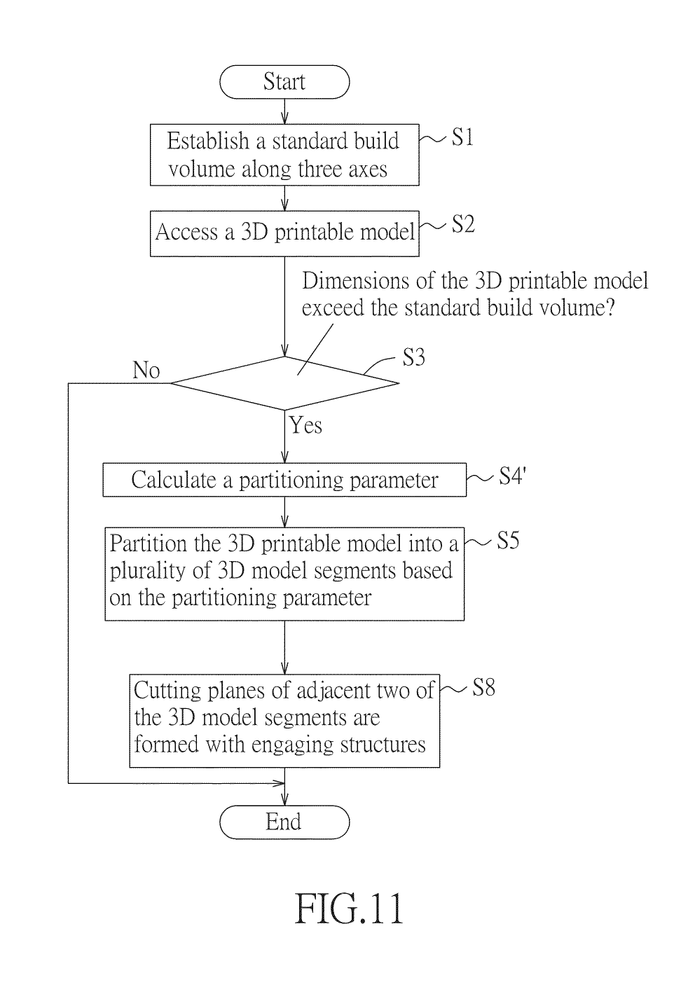

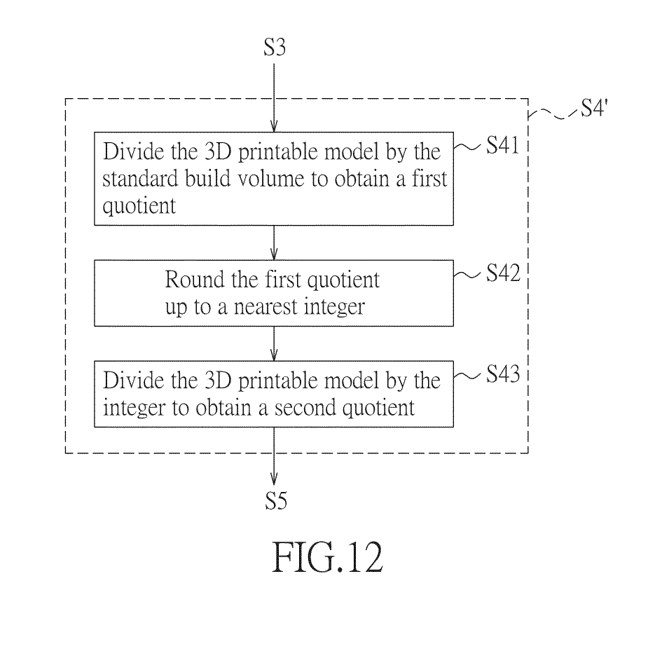

Referring to FIG. 11 and FIG. 12, a second embodiment of the method for partitioning a 3D printable model according to the present invention is illustrated. The second embodiment is similar to the first embodiment of FIG. 1, and differs from the first embodiment in the content of step S4′ and the omission of steps S6 and S7.

In step S4′, the model partitioning module 23 of the computer system 2 is configured to calculate a partitioning parameter. Specifically, step S4′ includes the following sub-steps.

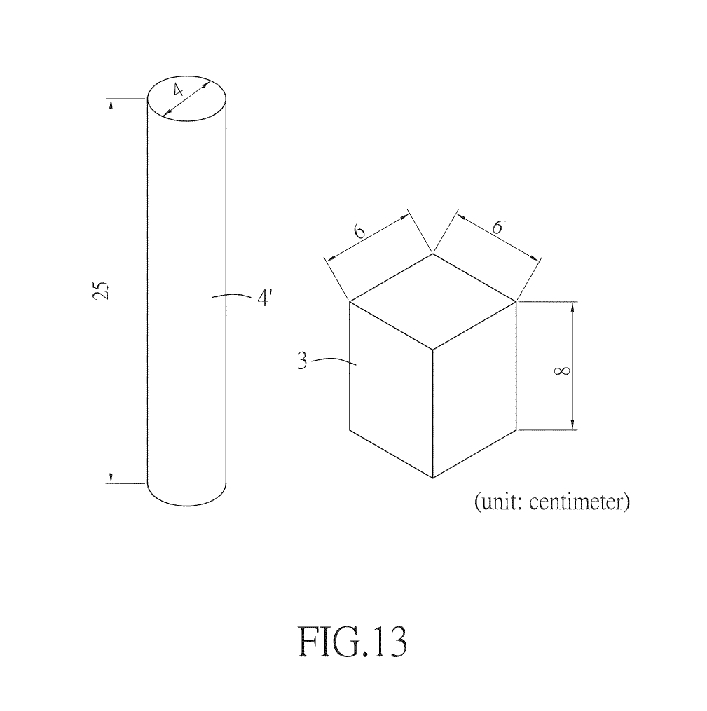

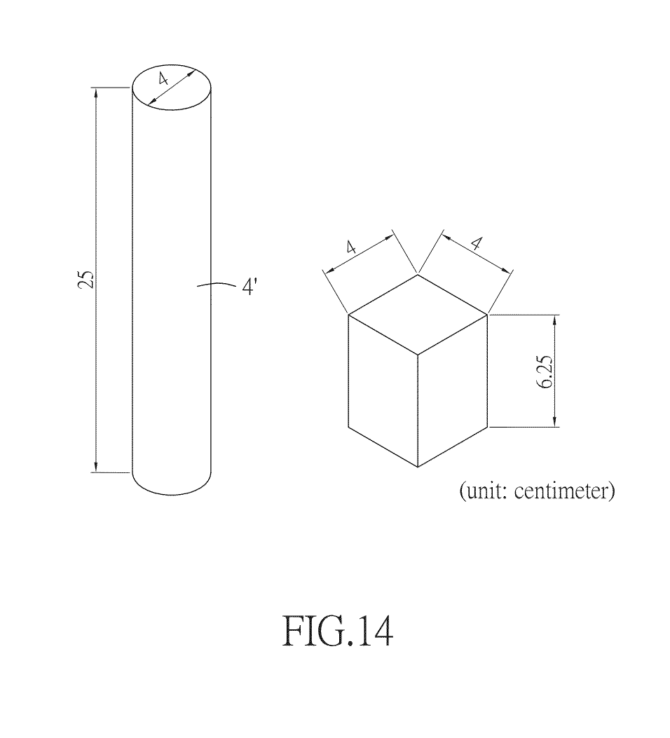

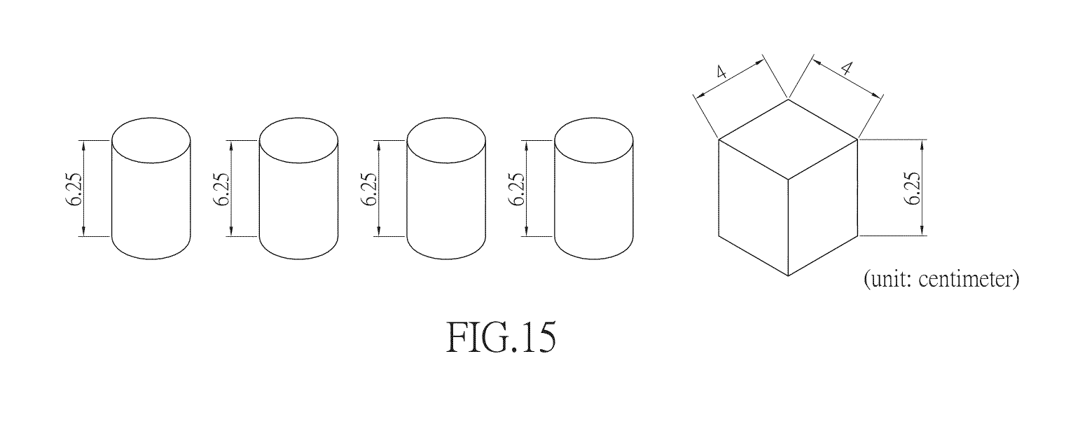

In step S41, the model partitioning module 23 divides one of the dimensions of the 3D printable model 4′ by a corresponding one of dimensions of the standard build volume 3 to obtain a first quotient (see FIG. 13). For example, a height of the 3D printable model 4′ is 25 centimeters, and the height of the standard build volume 3 is 8 centimeters. The first quotient can be obtained by dividing 25 by 8 and is equal to 3.125.

In step S42, the model partitioning module 23 rounds the first quotient up to a nearest integer. For example, the first quotient 3.125 is rounded up to the nearest integer 4.

In step S43, the model partitioning module 23 divides said one of the dimensions of the 3D printable model 4′ by the integer to obtain a second quotient which constitutes the partitioning parameter. For example, the height of the 3D printable model 4′ (25 centimeters) is divided by the integer 4 to obtain the second quotient which is equal to 6.25. The second quotient 6.25 may serve as a height component of the partitioning parameter. Therefore, by applying steps S41 to S43 to the remaining dimensions of the 3D printable model 4′ and the corresponding remaining dimensions of the standard build volume 3, the partitioning parameter having a length component of 4 centimeters, a width component of 4 centimeters and the height component of 6.25 centimeters can be thus calculated.

In this way, in step S5, the model partitioning module 23 is configured to partition the 3D printable model 4′ into a plurality of 3D model segments based on the partitioning parameter calculated in step S4′. For example, the 3D printable model 4′ can be partitioned into four 3D model segments each having a height of 6.25 centimeters. The flow may proceed to step S8 directly without undergoing steps S6 and S7 for ensuring that the dimensions of each of the 3D model segments are greater than the threshold volume. It is noted that the height of each of the 3D model segments may not exceed the height of the standard build volume (i.e., 6.25 centimeters<8 centimeters).

To sum up, in the embodiments mentioned above, the computer system 2 is used to establish the standard build volume 3 based on the stock build volume of a 3D printer, and partitions the 3D printable model into a plurality of 3D model segments each of which has dimensions smaller than the standard build volume 3 when the dimensions of the 3D printable model are determined to be greater than the standard build volume. Moreover, when dimensions of any of the 3D model segments are determined to be not greater than a threshold volume, the computer system is used to adjust the partitioning parameter, and re-partitions the 3D printable model based on the partitioning parameter thus adjusted. These steps are repeated until dimensions of each of the 3D model segments are greater than the threshold volume so as to prevent the issue that dimensions of some of the 3D model segments are too small for subsequent assembly processing. Further, at least one cutting surface of each of the 3D model segments is formed with at least one engaging structure to be coupled to an adjacent one of the 3D model segments. In this way, once the physical 3D objects have been printed by the 3D printer from the 3D model segments, the physical 3D objects may be aligned and combined effectively by virtue of the engaging structures during assembly of the physical 3D objects.

While the present invention has been described in connection with what are considered the most practical embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method for partitioning a three-dimensional (3D) printable model, the method to be implemented using a computer system and comprising the steps of:
(A) establishing, using the computer system, a standard build volume along three axes;
(B) accessing, using the computer system, the 3D printable model, and accessing a preset, partitioning parameter upon determining that dimensions of the 3D printable model thus accessed exceed the standard build volume;
(C) partitioning, by the computer system, the 3D printable model into a plurality of 3D model segments, which have dimensions smaller than the standard build volume, based on the partitioning parameter;
(D) determining, by the computer system, whether dimensions of each of the 3D model segments are greater than a threshold volume;
(E) when a result of the determination made in step (D) is negative, adjusting, using the computer system, the partitioning parameter, and performing steps (C) and (D); and
(F) when the result of the determination made in step (D) is affirmative, modifying, using the computer system, any adjacent two of the 3D model segments by forming corresponding engaging structures respectively on corresponding cutting planes of said adjacent two of the 3D model segments.

2. The method according to claim 1,
wherein, in step (B), the partitioning parameter is set according to a predefined standard partitioning volume; and
wherein, in step (B), the partitioning parameter is adjusted by adjusting dimensions of the standard partitioning volume, so that the dimensions of each of the 3D model segments are adjusted correspondingly in step (C).

3. The method according to claim 1,
wherein, in step (B), the partitioning parameter is set according to a predefined standard partitioning volume; and
wherein, in step (E), the partitioning parameter is adjusted by adjusting the standard partitioning volume particularly for one of the 3D model segments whose dimensions are not greater than the threshold volume, and particularly for another one of the 3D model segments which is adjacent to said one of the 3D model segments.

4. The method according to claim 1,
wherein, in step (B), the partitioning parameter includes a plurality of distinct predefined standard partitioning volumes; and
wherein, in step (E), the partitioning parameter is adjusted by adjusting dimensions of the standard partitioning volumes, so that the dimensions of the 3D model segments are adjusted correspondingly in step (C).

5. The method according to claim 1,
wherein, in step (B), the partitioning parameter includes a plurality of distinct predefined standard partitioning volumes; and
wherein, in step (E), the partitioning parameter is adjusted by respectively adjusting the standard partitioning volumes particularly for one of the 3D model segments whose dimensions are not greater than the threshold volume, and particularly for another one of the 3D model segments which is adjacent to said one of the 3D model segments.

6. The method according to claim 1, wherein the partitioning parameter is set to ensure that dimensions of each of the 3D model segments, which are formed with respective one of the engaging structures, are smaller than the standard build volume.

7. The method according to claim 1, wherein, in step (D), the threshold volume is set according to dimensions of the engaging structures.

8. The method according to claim 1, wherein one the engaging structures formed on a respective one of the cutting surfaces includes a mortise, and the other one of the engaging structures formed on a respective one of the cutting surfaces includes a tenon which is insertable into and tightly engages the mortise.

9. The method according to claim 1, wherein the corresponding cutting planes of said adjacent two of the 3D model segments are formed with corresponding indication patterns, respectively.

10. The method according to claim 9, wherein each of the indication patterns includes at least one alphanumeric character.

11. A computer system for partitioning a three-dimensional (3D) printable model, the computer system comprising:
a build volume creation module for establishing a standard build volume along three axes;
a size determination module which accesses the 3D printable model, and which determines whether dimensions of the 3D printable model exceed the standard build volume; and
a model partitioning module
which partitions the 3D printable model into a plurality 3D model segments, which have dimensions smaller than the standard build volume, based on a preset, partitioning parameter when said size determination module determines that the dimensions of the 3D printable model exceed the standard build volume,
which adjusts the partitioning parameter upon determining that dimensions of at least one of the 3D model segments are not greater than a threshold volume,
which re-partitions the 3D printable model into a plurality of 3D model segments, which have dimensions smaller than the standard build volume, based on the partitioning parameter thus adjusted, and
which modifies any adjacent two of the 3D model segments by forming corresponding engaging structures respectively on corresponding cutting planes of said adjacent two of the 3D model segments.

12. The computer system according to claim 11,
wherein the partitioning parameter is set according to a predefined standard partitioning volume; and
wherein said model partitioning module partitions the 3D printable model into the plurality of 3D model segments based on the standard partitioning volume, and adjusts dimensions of the standard partitioning volume, so that the dimensions of each of the 3D model segments are adjusted correspondingly.

13. The computer system according to claim 11,
wherein the partitioning parameter is set according to a predefined standard partitioning volume; and
wherein said model partitioning module partitions the 3D printable model into the plurality of 3D model segments based on the standard partitioning volume, and adjusts the standard partitioning volume particularly for one of the 3D model segments whose dimensions are not greater than the threshold volume, and particularly for another one of the 3D model segments which is adjacent to said one of the 3D model segments.

14. The computer system according to claim 11,
wherein the partitioning parameter includes a plurality of distinct predefined standard partitioning volumes; and
wherein said model partitioning module partitions the 3D printable model into the plurality of 3D model segments with different dimensions based on the standard partitioning volumes, and adjusts dimensions of the standard partitioning volumes, so that the dimensions of the 3D model segments are adjusted correspondingly.

15. The computer system according to claim 11,
wherein the partitioning parameter includes a plurality of distinct predefined standard partitioning volumes; and
wherein said model partitioning module partitions the 3D printable model into the plurality of 3D model segments with different dimensions based on the standard partitioning volumes, and respectively adjusts the standard partitioning volumes particularly for one of the 3D model segments whose dimensions are not greater than the threshold volume, and particularly for another one of the 3D model segments which is adjacent to said one of the 3D model segments.

16. The computer system according to claim 11, wherein the partitioning parameter is set to ensure that dimensions of each of the 3D model segments, which are formed with a respective one of the engaging structures, are smaller than the standard build volume.

17. The computer system according to claim 11, wherein the threshold volume is set according to dimensions of the engaging structures.

18. The computer system according to claim 11, wherein one the engaging structures formed on a respective one of the cutting surfaces includes a mortise, and the other one of the engaging structures formed on a respective one of the cutting surfaces includes a tenon which is insertable into and tightly engages the mortise.

19. The computer system according to claim 11, wherein the corresponding cutting planes of said adjacent two of the 3D model, segments are formed with corresponding indication patterns, respectively.

20. The computer system according to claim 19, wherein each of the indication patterns includes at least one alphanumeric character.

21. A method for partitioning a three-dimensional (3D) printable model, the method to be implemented using a computer system and comprising the steps of:
establishing, using the computer system, a standard build volume along three axes;
accessing, using the computer system, the printable model;
calculating, by the computer system, a partitioning parameter based on dimensions of the 3D printable model and the standard build volume upon determining that the dimensions of the 3D printable model thus accessed exceed the standard build volume;
partitioning, by the computer system, the 3D printable model into a plurality of 3D model segments, which have dimensions smaller than the standard build volume, based on the partitioning parameter thus calculated; and
modifying, using the computer system, any adjacent two of the 3D model segments by forming corresponding engaging structures respectively on corresponding cutting planes of said adjacent two of the 3D model segments.

22. The method according to claim 21, wherein the step of calculating a partitioning parameter includes the sub-steps of:
dividing one of the dimensions of the 3D printable model by a corresponding one of dimensions of the standard build volume to obtain a first quotient;
rounding the first quotient up to a nearest integer; and
dividing said one of the dimensions of the 3D printable model by the integer to obtain a second quotient which constitutes the partitioning parameter.
